(19) United States
(12) Patent Application Publication
(10) Pub. No.: US 2008/0245137 A1
(43) Pub. Date: Oct. 9, 2008

(54) METHOD AND APPARATUS FOR ESTIMATING SOLIDS CONCENTRATION IN SLURRIES

(76) Inventors: Lawrence L. Tavlarides, Fayetteville, NY (US); Michael Norato, Aiken, SC (US); Alexander Shcherbakov, Syracuse, NY (US); Ashok Sangani, Fayetteville, NY (US)

Correspondence Address: BURR & BROWN, PO BOX 7068, SYRACUSE, NY, 13261-7068, US

(21) Appl. No.: 12/137,083

(22) Filed: Jun. 11, 2008

Related U.S. Application Data
(63) Continuation of application No. 11/187,688, filed on Jul. 22, 2005.
(60) Provisional application No. 60/590,633, filed on Jul. 23, 2004.

(51) Int. Cl. G01N 29/032

(52) U.S. Cl. 73/61.75

(57) ABSTRACT

Methods of estimating concentration of solids in a slurry comprising solid material, liquid material, and optionally also gaseous material comprise passing a first ultrasonic pulse through a portion of the slurry, measuring amplitude of the first ultrasonic pulse, removing solid material from a portion of the slurry to provide a filtered liquid, passing a second ultrasonic pulse through a portion of the filtered liquid, and measuring amplitude of the second ultrasonic pulse. Measuring devices comprise a measuring device body having a passageway extending therethrough, and a sending transducer which sends ultrasonic pulses and which is mounted on the measuring device body. A system for estimating concentration of solids in a slurry comprises a containment structure defining a space for receiving a portion of the slurry, a containment structure defining a space for receiving a liquid material included in the slurry, and receiving transducers mounted on each of the containment structures.

### CROSS REFERENCE TO RELATED APPLICATIONS

This application is a continuation of U.S. application Ser. No. 11/187,688, filed Jul. 22, 2005, and claims the benefit of U.S. Provisional Application Ser. No. 60/590,633, filed Jul. 23, 2004, the entireties of which are incorporated herein by reference.

### GOVERNMENT RIGHTS

The United States Government has rights in this invention pursuant to EMSP Grant No. DE-FG07-96-ER1429 between the United States Department of Energy and Syracuse University.

### FIELD OF THE INVENTION

This invention relates generally to measuring methods and apparatus for measuring, and is more particularly directed to the measurement of the relative amounts of solid particles (“solids”) suspended in a solid-liquid slurry with or without the presence of gas. The present invention is also directed to methods and systems in which the attenuation of ultrasound through a solid-liquid slurry is employed to derive the percentage by weight of solid particles in the slurry, with or without the presence of gas in the slurry. The present invention is also directed to acoustic monitors for use in such methods and systems. The present invention is also directed to an acoustic monitor for use in detecting relative amounts of solid particles.

### BACKGROUND OF THE INVENTION

Measurement of the solid weight percentage in a solid-liquid slurry has been attempted by such techniques as grab sampling (see “Comparative Testing of Pipeline Slurry Monitors,” www.cmst.org/publications/tech_summ_{—}98/Pipeline Slurry Mon.pdf (last visited Mar. 1, 2003), Coriolis meters (“Comparative Testing of Pipeline Slurry Monitors,” Id.), focused-beam reflectance measurements (“Comparative Testing of Pipeline Slurry Monitors,” Id.), and Doppler technology (see McLeod, F., “Directional Doppler Flowmeter,” Intl. Conf. Med. Bio. Eng., Stockholm, 213, (1967); Katronic Information, www.katronic.co.uk (last visited Feb. 26, 2003); Retrieve and Transfer DST Waste Information, www.hanford.gov/boards/stcg/documents/itp02/sec6.pdf (last visited Feb. 4, 2003); and Pappas, Richard A., “Streamnlining Processes”, American Society of Agricultural Engineers, May 1, 2002), as well as other ultrasonic methods (see Atkinson, C. M. and Kytomaa, H. K., “Acoustic Properties of Solid-Liquid Mixtures and the Limits of Ultrasound Diagnostics-1. Experiments,” J. Fluids Eng. 115, 665, (1993); Greenwood, M. S., Mai, J. L., and Good, M. S., “Attenuation Measurements of Ultrasound in a Kaolin-Water Slurry: A Linear Dependence Upon Frequency,” J. Acoust. Soc. Am. 94, 908, (1993); Allegra, J. R. & Hawley, S. A., “Attenuation of Sound in Suspensions and Emulsions: Theory and Experiments,” J. Acoust. Soc. Am., 51, 1545-1563 (1972); Sayan, P. and Ulrich, J., “The Effect of Particle Size and Suspension Density on the Measurement of Ultrasonic Velocity in Aqueous Solutions,” Chem. Eng. and Processing, 41, 281-287, (2002); Stolojanu, V. and Prakash A., “Characterization of Slurry Systems by Ultrasonic Techniques,” Chem. Eng. J., 84, 215-222, (2001); Guidarelli, G., Craciun, F., Galassi, C., and Roncari, E., “Ultrasonic Characterisation of Solid-Liquid Suspensions,” Ultrasonics, 36, 467-470, (1998); Greenwood, M. S., Skorpik, J. R., Bamberger, J. A., and Harris, R. V., “On-Line Ultrasonic Density Sensor for Process Control of Liquids and Slurries,” Ultrasonics, 37, 159-171, (1999); Greenwood, M. S., and Bamberger, J. A., “Ultrasonic Sensor to Measure the Density of a Liquid or Slurry During Pipeline Transport,” Ultrasonics, 40, 413-417, (2002); and Greenwood, M. S., and Bamberger, J. A., “Measurement of Viscosity and Shear Wave Velocity of a Liquid or Slurry for On-Line Process Control,” Ultrasonics, 39, 623-630, (2002)). While these approaches can be employed to derive a result, the first two cannot be considered non-intrusive and non-invasive, and grab sampling cannot occur in real time (or in substantially real time). Additionally, each of these technologies has a considerable degree of inaccuracy.

The solid weight percentage would be an important parameter to determine to permit appropriate processing of slurries in the food, pharmaceutical, and nuclear waste industries. Accurate, real-time knowledge of this quantity would permit rapid response to changes in solids concentration to adjust processing parameters in downstream and upstream units in an appropriate fashion. It also would permit real-time information as to when slurries have reached desired concentrations in solids-concentrating filtration loops. Therefore, it would be desirable to achieve accurate, non-invasive, non-intrusive, on-line, real-time measurements of this parameter.

One previous approach to ultrasonic measurement of this quantity employed an in-line probe to monitor radioactive slurries suspended with Pulsair mixers (see Hylton, T. D. and Bayne, C. K., “Testing of In-Line Slurry Monitors and Pulsair Mixers with radioactive slurries,” ORNL/TM-1999/111, July, 1999). This technique did not compare well with other instruments.

### BRIEF SUMMARY OF THE INVENTION

One of the difficulties encountered in using acoustic techniques for monitoring suspensions is the interference caused by gas bubbles that may be present in the system. Since the compressibility of bubbles is much greater than that of liquid or solid particles, the attenuation of ultrasonic pulses can be considerably affected by the presence of gas bubbles. This effect can be significant even when the gas volume fraction is much smaller than the solid volume fraction.

It is an object of this invention to provide a method and apparatus for measuring the solid concentration as weight percentage in an ongoing process involving solid-liquid slurries without the presence of gas, or with a slight presence of gas, or with the presence of a substantial amount of gas, and which avoids the drawbacks of the prior art.

It is another object of this invention to provide a technique for measuring the solid weight percentage in which the measurement is self-calibrating, non-invasive, non-intrusive, and substantially in real time.

It is still another object of this invention to provide such a technique in which the measurement devices can be disposed externally of the process stream, avoiding disturbance of flow patterns of the fluids within the process stream and avoiding contact of the active surfaces of the measurement devices with possibly corrosive and abrasive chemicals within the stream.

In accordance with a first aspect of the present invention, the above objects are achieved by using a “maximum slope method”, i.e., by:

(1) measuring, at different frequencies (f) an attenuation ratio (α) calculated according to the formula:

α(f)=−(1/d₁)ln [Aₛₗ/Aₛᵤ^{(d1/d2)}],

where:
Aₛₗ=adjusted amplitude for ultrasound passed through a slurry sample;
Aₛᵤ=adjusted amplitude for ultrasound passed through supernate sample, i.e., slurry sample from which solid material has been removed (and, if gas is present in the slurry sample, gas has also been removed); and
d₁, d₂=the distance through which the ultrasound travels through the slurry and supernate samples respectively;

(2) determining the maximum slope of a plot of a versus frequency, and

(3) determining the solids percentage by multiplying the maximum slope by a first calibration factor, and adding a second calibration factor, the first and second calibration factors being determined by calibration procedure.

The behavior of the plot of attenuation ratio α versus frequency f is significantly different for slurries containing solid particles versus slurries containing gas bubbles. Specifically, a plot of attenuation ratio α for a gas-liquid slurry has a slope of approximately zero while a plot of attenuation ratio α for a solid-liquid curve has a definite and discernable slope over the frequency range of interest to this invention.

For example, attenuation ratio data can be modeled as:

α(f)=af²+bf+c

The derivative of α (f) is then taken, to produce:

α′(f)=2af+b

This slope is preferably taken over multiple frequencies. α′ₘₐₓ (f) is defined as the maximal value of the slope and may occur over a significant portion of the range of operation. This procedure is preferably repeated multiple times to obtain an average value of the slope, α′ₘₐₓ (f). This value is then related to concentration by the expression:

c=k₁α′ₘₐₓ+k₂

where k₁ and k₂ are the slope and intercept, respectively, of an off-line, bench-scale slope (α′ₘₐₓ, i.e., maximum slope of α vs. frequency) versus concentration plot, which shows a linear or substantially linear relationship. That is, k₁ and k₂ are determined by calibration, e.g., by determining α′ₘₐₓ using the technique described herein for at least two samples of known concentration, and then solving for k₁ and k₂. The expression “substantially linear”, as used herein, means that (1) a line connecting any pair of points which are both located in the portion of the plot which is substantially linear and which points are spaced by at least one fifth of the length of the portion of the plot, and (2) a line connecting any other pair of points in the portion of the plot which is substantially linear and which points are spaced by at least one fifth of the length of the portion of the plot, define an angle not greater than 5 degrees.

In accordance with a second aspect of the present invention, the above objects are achieved by using a “concentration vs. attenuation ratio method”, i.e., by:

(1) measuring, at a selected frequency (f), a detected attenuation ratio (α) calculated according to the formula:

α(f)=−(1/d₁)ln [Aₛₗ/Aₛᵤ^{(d1/d2)}],

where:
Aₛₗ=adjusted amplitude for ultrasound passed through a slurry sample;
Aₛᵤ=adjusted amplitude for ultrasound passed through supernate sample, i.e., slurry sample from which solid material has been removed (and, if gas is present in the slurry sample, gas has also been removed); and
d₁, d₂=the distance through which the ultrasound travels through the slurry and supernate samples respectively; and

(2) estimating a concentration of solid material in said slurry by correlating the detected attenuation ratio α with a plot of concentration vs. attenuation ratio for such selected frequency.

Preferably, such estimation of concentration is carried out by multiplying the detected attenuation ratio by a calibration factor for the selected frequency (i.e., where the attenuation ratio is a value at which the concentration vs. detected attenuation plot is substantially linear), the calibration factor having been determined by calibration. Plots of concentration vs. attenuation ratio, at given frequencies, are at least roughly linear for some slurries at some concentrations (e.g., typically at lower concentrations and at lower frequencies, such as below about 7 weight percent, especially below about 3 weight percent, and even more particularly at about 1 weight percent and below, and at frequencies below about 9 MHz, especially below about 7 MHz, and even more particularly below about 5 MHz. Calibration and testing can be carried out for slurries at various concentrations in order to ascertain relative degrees of accuracy for concentration values estimated by assuming linear behavior, i.e., by multiplying the detected attenuation ratio by a calibration factor for the selected frequency.

The maximum slope method, referred to above, is particularly useful where the concentration of gas is higher and/or where the concentration of solids is higher.

The present invention also provides acoustic monitor systems by which such methods of detection can be carried out, and measuring devices for use in acoustic monitor systems. Such a system and/or such measuring device can, if desired, be used in both a maximum slope method and/or in a concentration vs. attenuation ratio method (i.e., the same system or measuring device can be used for carrying out both methods). In order to carry out such methods, the systems according to the present invention preferably include processors, e.g., computers (which may be isolated or part of a network), and the systems according to the present invention preferably include means for making the required calculations, e.g., software loaded on one or more processors, software accessed via a local area network or via the internet, software loaded on one or more a computer-readable medium (e.g., a hard drive, a compact disc, a floppy disc or magnetic tape).

In accordance with the present invention, α is determined for a single frequency, or for each of a plurality of frequencies, by producing an ultrasonic signal at the frequency or frequencies being employed, causing the ultrasonic signal to pass through at least a portion of the slurry being examined, and then receiving the ultrasonic signal, modified in accordance with acoustic properties of the slurry.

An acoustic monitoring technique which can be utilized is a “pitch-catch” method. In such a method, a signal is pulsed by a sending transducer and passes through the medium of interest and is received by a receiving transducer on the opposite side of the medium. Thus, two transducers are used in tandem for a pitch-catch method.

Another acoustic monitoring technique which can be utilized is a “reflection” method. In such a method, a signal is pulsed by a first transducer (i.e., a sending transducer or a sending and receiving transducer), passes through the medium of interest, is reflected by a reflector (which may be any structure which can reflect an ultrasonic wave, such as an imposed reflecting plate or a wall of a containment structure, e.g., a pipe, a tank or other vessel), passes back through the medium of interest, and is then received by the first transducer (i.e., where the first transducer is a sending and receiving transducer) or by a second transducer (i.e., a receiving transducer). Thus, a sending and receiving transducer (i.e., a transducer which both sends and receives ultrasonic signals) can be used in a reflecting method, or a pair of transducers (i.e., a sending transducer and a receiving transducer) can be used.

For example, (1) an ultrasonic signal may be generated in a first ultrasonic transducer, then passed through at least a portion of the thickness of a wall of a vessel in which the slurry is located, then passed through at least a portion of the slurry, then passed through at least a portion of the thickness of a wall of the vessel, and then received by a second ultrasonic transducer, or (2) an ultrasonic signal may be generated in a first ultrasonic transducer, then passed through at least a portion of the thickness of a wall of the vessel in which the slurry is located, then passed through at least a portion of the slurry, and then received by a second ultrasonic transducer (i.e., without again passing through at least a portion of the thickness of a wall of the vessel), or (3) an ultrasonic signal may be generated in a first ultrasonic transducer, then passed through at least a portion of the slurry, and then received by a second ultrasonic transducer, or (4) an ultrasonic signal may be generated in a first ultrasonic transducer, then passed through at least a portion of the slurry, then passed through at least a portion of the thickness of a wall of the vessel, and then received by a second ultrasonic transducer, or (5) an ultrasonic signal may be generated in a first ultrasonic transducer, then passed through at least a portion of the thickness of a wall of a vessel in which the slurry is located, then passed through at least a portion of the slurry, then reflected (by a reflector, by a wall of the vessel, or by any other structure which can reflect an ultrasonic pulse), then passed back through at least a portion of the slurry, then passed back through at least a portion of the thickness of the wall of the vessel, and then received by the first ultrasonic transducer or by a second ultrasonic transducer, or (6) an ultrasonic signal may be generated in a first ultrasonic transducer, then passed through at least a portion of the slurry, then reflected (by a reflector, by a wall of the vessel, or by any other structure which can reflect an ultrasonic pulse), then passed back through at least a portion of the slurry, and then received by the first ultrasonic transducer or by a second ultrasonic transducer, or (7) an ultrasonic signal may be generated in a first ultrasonic transducer, then passed through at least a portion of the thickness of a wall of a vessel in which the slurry is located, then passed through at least a portion of the slurry, then passed through at least a portion of the thickness of a wall of the vessel, then reflected (by a reflector or by any other structure which can reflect an ultrasonic pulse), then passed back through at least a portion of the thickness of a wall of the vessel, then passed back through at least a portion of the slurry, then passed back through at least a portion of the thickness of the wall of the vessel, and then received by the first ultrasonic transducer or by a second ultrasonic transducer, or (8) an ultrasonic signal may be generated in a first ultrasonic transducer, then passed through at least a portion of the slurry, then passed through at least a portion of the thickness of a wall of the vessel, then reflected, then passed back through at least a portion of the thickness of a wall of the vessel, then passed back through at least a portion of the slurry, and then received by the first ultrasonic transducer or by a second ultrasonic transducer.

The received ultrasonic signal is converted by the ultrasonic transducer into the form of an electric voltage as a function of time which is then further processed. This function processing can be accomplished, for example, by obtaining the spectral conversion (i.e., the Fourier transform) of this received ultrasonic signal passed through the medium of interest to obtain the amplitude of the signal, A, either in the slurry or in the supernate. The units of A can be selected to be voltage/MHz, or (voltage)²/MHz, or any other comparable units.

Transducers are in general designed to have an optimum range of frequencies over they are most effective. As such, particularly for a maximum slope method, it is often preferable to use multiple pairs of transducers (each pair using a pitch-catch method) with different nominal frequencies substantially simultaneously to cover a broad range of frequencies (or, for a reflection method, multiple transducers with different nominal frequencies substantially simultaneously to cover a broad range of frequencies). The respective ranges of frequency for the respective transducers typically overlap to some extent. While devices including one, two and three pairs of transducers, and devices including one, two and three sending and receiving transducers are specifically mentioned herein, any number of pairs of transducers (i.e., each pair including a sending transducer and a receiving transducer) and/or sending and receiving transducers can be employed in any measuring device according to the present invention as described herein. The expression “substantially simultaneously”, as used herein, means that the respective events each occur within a short period of time, e.g., within one minute, preferably within 10 seconds, more preferably within 1 second or less, even though such events may occur sequentially (e.g., the events in a sequence in which a first pulse is sent from a first transducer, then the first pulse is received by a second transducer, then a second pulse is sent from a third transducer, then the second pulse is received by a fourth transducer, then a third pulse is sent from a fifth transducer, and then the third pulse is received by a sixth transducer may occur within a fraction of a second, would, in accordance with the present description, be characterized as being “substantially simultaneous”).

In accordance with a preferred aspect of the present invention, the measurement of α is carried out with multiple pairs of ultrasonic transducers disposed externally of the process stream on two measuring devices. One measuring device (containing one or more sending transducers and one or more receiving transducers) is installed in the process stream (i.e., unfiltered slurry) while the other measuring device (likewise containing one or more sending transducers and one or more receiving transducers) is installed on a filtered side stream (i.e., supernate). In each measuring device, ultrasonic pulses are produced in the sending transducers, passed through the vessel in which the fluid being examined (slurry or supernate) is contained and is later received by a corresponding receiving transducer on an opposite side of the vessel (alternatively, where the pulses are reflected, they are received by the same transducer, i.e., a sending and receiving transducer, or they are received by a separate receiving transducer). Preferably, a first circuit for electrically exciting the transducers is electrically connected to the sending transducers and a second circuit for sensing the presence of the received signals is electrically connected to the receiving transducers. These electronics are controlled via a computer console, which is also used to calculate the attenuation α, and then to carry out computation of the solid weight percentage according to one of the methods described herein.

The invention may be more fully understood with reference to the accompanying drawings and the following detailed description of the invention.

### BRIEF DESCRIPTION OF THE DRAWING FIGURES

FIG. 1 is a schematic view of an ultrasonic measuring device in accordance with a preferred embodiment of the present invention.

FIG. 2A is a cross-sectional view of an ultrasonic measuring device in accordance with a preferred embodiment of the present invention.

FIG. 2B is a cross-sectional view of an ultrasonic measuring device in accordance with another preferred embodiment of the present invention.

FIG. 3 is a cross-sectional view of another embodiment of an ultrasonic measuring device according to the present invention.

FIG. 4 is a schematic view of a main slurry flow loop in accordance with a preferred embodiment of the present invention.

FIG. 5 is a schematic view of a slurry side stream, a filtration system, and a supernate measuring device in accordance with a preferred embodiment of the present invention.

FIG. 6A is a chart showing a representative example of a shape of a received signal for a pair of 10 MHz nominal transducers.

FIG. 6B is a chart showing a representative example of shape of a spectrum of the received signal for a pair of 10 MHz nominal transducers.

FIG. 7 is a chart showing a representative example of a shape of an attenuation-frequency curve for 7.5 wt % ceramic microspheres in water, for use in a maximum slope method or in a concentration vs. attenuation ratio method.

FIG. 8 is a chart showing real-time experimental concentration data taken in the flow loop of the embodiment of a main slurry flow loop depicted in FIG. 4 using a concentration vs. attenuation ratio method and in the side stream of the embodiment depicted in FIG. 5.

FIG. 9 is a chart showing the experimental concentration data of FIG. 8 versus actual concentrations obtained from the in-line sample port in the embodiment of a main slurry flow loop depicted in FIG. 4.

FIG. 10 is a chart showing experimental attenuation versus frequency data for three various systems from the embodiment of a main slurry flow loop depicted in FIG. 4 as well as predicted data of one system.

FIG. 11 is a chart showing real-time, experimentally observed concentration data via a concentration vs. attenuation ratio method and via a maximum slope method from the embodiment of a main slurry flow loop depicted in FIG. 4.

FIG. 12 is a chart showing experimentally observed concentration data versus actual solids concentration data (with varying gas concentration) via a concentration vs. attenuation ratio method at three frequencies and via a maximum slope method from the embodiment of a main slurry flow loop depicted in FIG. 4.

FIG. 13A depicts examples of plots of concentration vs. attenuation ratio at various frequencies.

FIG. 13B depicts examples of plots of concentration vs. attenuation ratio at various frequencies.

FIG. 14 is a perspective view depicting an embodiment of a measuring device according to the present invention.

FIG. 15 is a sectional view depicting an embodiment according to the present invention of an arrangement of a sending transducer and a receiving transducer relative to a containment structure.

FIG. 16 is a side view of the embodiment depicted in FIG. 15.

FIG. 17 is a top view of the embodiment depicted in FIG. 15.

FIG. 18 is a perspective view of an embodiment according to the present invention of an arrangement of a sending transducer and a receiving transducer relative to a containment structure.

FIG. 19 is a perspective view of an embodiment according to the present invention of an arrangement of a sending and receiving transducer and a reflector relative to a containment structure.

FIG. 20 is a perspective view of an embodiment according to the present invention of an arrangement of a sending transducer and a receiving transducer relative to a containment structure.

FIG. 21 is a sectional view of an embodiment according to the present invention of an arrangement of a sending transducer and a receiving transducer relative to a containment structure.

FIG. 22 is a cutaway perspective view of an embodiment according to the present invention of an arrangement of a measuring device mounted in a vessel.

FIG. 23 depicts an embodiment of an embodiment of a measuring device according to the present invention.

### DETAILED DESCRIPTION OF THE INVENTION

In a preferred aspect, the present invention can provide a self-calibrated continuous measurement of the weight percentage of solids in a liquid slurry (with or without the presence of one or more gas), and continuous monitoring of slurry, as the weight percentage of solids can change during the time the slurry is being monitored. The invention can be applied in-line to flows through pipelines as well as in-tank for various reaction vessels.

In this document, “self-calibration” is defined as a process by which the monitor is “calibrated” when put in service by comparing the signal for a liquid, e.g., pure water (or any other fluid), flowing through the slurry measuring device with the signal from the supernate measuring device (such calibration is described in more detail below) without invoking any extra equipment to perform this operation.

In a system designed to test the effectiveness of a method according to the present invention, a slurry containing solid particles suspended in a liquid is kept well mixed in a mixing vessel using mechanical agitation. This solid-liquid slurry is pumped through a process stream pipeline for monitoring. Gas can be injected into the process stream or generated inside the medium as a result of its physical and/or chemical nature in the form of small bubbles, which are likewise dispersed throughout the process stream. The attenuation ratio α of the ultrasonic pulses through the slurry can be monitored continuously, and the solid weight percentage can be calculated and displayed substantially in real-time (the expression “substantially in real-time”, as used herein, means with a relatively short period between events, e.g., a reading within 10 seconds, preferably 1 second or less, after the occurrence of the event from which the reading is derived).

In accordance with the present invention, slurry to be monitored is contained in or is passing through any kind of vessel, e.g., a pipeline, a tank or any other vessel which might be used to store and/or transport a slurry. In one aspect of the invention, at least one sending transducer which sends at least one ultrasonic pulse and at least one receiving transducer for receiving the at least one ultrasonic pulse are positioned such that the at least one ultrasonic pulse will travel through at least a portion of the distance between walls of the vessel, and thereby through a portion of the slurry, as the pulse moves from the sending transducer to the receiving transducer. As described in more detail below, in certain circumstances, a single transducer can function both as a sending transducer and as a receiving transducer for one or more ultrasonic pulses. Alternatively, a sending transducer and a receiving transducer can be employed such that the sending transducer sends at least one ultrasonic pulse, the ultrasonic pulse travels through at least a portion of the slurry, the ultrasonic pulse is then reflected, the ultrasonic pulse travels back through the slurry, and the receiving transducer (which may be positioned at any desired location relative to the sending transducer, so long as it is in position to receive the reflected pulse) then receives the reflected pulse. In addition, preferably a vessel is provided through which at least a portion of the slurry can be drawn and filtered to remove substantially all of the solids and preferably also substantially all of any gases (if present) contained therein, to produce a supernate. The expression “substantially all”, as used herein, means at least 90%, preferably at least 95%, more preferably at least 99%, and most preferably at least 99.9%. At least one sending transducer and at least one receiving transducer are positioned such that at least one ultrasonic pulse travels through a portion of the supernate as the pulse moves from the sending transducer to the receiving transducer. Preferably, the sending and receiving transducer(s) for the supernate are separate from the sending and receiving transducer(s) for the slurry, although it would be possible for a single ultrasonic measuring device (including at least one sending transducer and at least one receiving transducer, which may be the same transducer) to sequentially analyze the slurry as well as the supernate.

Where one or more transducers are positioned outside the walls of the vessel (or within the walls of the vessel), such that it is necessary for ultrasound to be passed through one or more walls of the vessel, the vessel should be such that ultrasound can pass through at least sections of the vessel in order for the ultrasound to travel on its desired course.

For example, the present invention provides devices which comprise a containment structure in the form of a section of pipe positioned between a pair of flanges and one or more transducers mounted on or in the walls of the containment structure, such that slurry flows through or is contained within the section of pipe. Such devices include devices where the transducers are in contact with the slurry as well as devices in which at least part of the wall of the containment structure are positioned between one or more of the transducers and the slurry. In connection with devices where at least some containment structure is positioned between one or more of the transducers and the slurry, preferably, the portion or portions of the containment structure which is positioned between a transducer and the slurry is/are, in addition to having sufficient mechanical strength, “acoustically transparent.” The expression “acoustically transparent,” as used herein, in describing a material, means that the material has the same or similar acoustic properties as does the slurry being analyzed, i.e., ultrasonic waves being passed through the material is affected in a manner which is similar to how substantially similar ultrasonic waves are affected when passed through the slurry. In order to test whether a particular material is “acoustically transparent,” substantially similar ultrasonic pulses can be sent into the material and a representative slurry, and respective voltage² vs. frequency plots can be compared. For example, representative materials which are “acoustically transparent” with respect to many slurries include plastics such as acrylic resin and polyetherimide resin (e.g., as sold by General Electric Company under the trademark “ULTEM®”), polyetherimide resin being particularly resistant to radiation, and acrylic resin being generally less expensive, such materials generally having sufficient mechanical strength. The present invention includes embodiments in which the portion or portions of the containment structure which is/are positioned between transducers and the slurry are in the form of windows of acoustically transparent material, e.g., acrylic resin or polyetherimide resin (while the remainder of the containment structure comprises, for example, stainless steel). The present invention further includes embodiments in which a larger portion of, or the entirety of, the containment structure is made of acoustically transparent material, e.g., acrylic resin or polyetherimide resin.

Also, it is possible to carry out the present invention by sending one or more ultrasonic pulse through a first portion of the slurry, then removing solid material from that portion to provide a supernate, and then sending one or more ultrasonic pulses through that supernate. In such a case, the first portion of the slurry and the supernate are characterized herein as “substantially the same portion of the slurry”, even though solid material, and possibly liquid and gaseous material, which was contained in the first portion of the slurry is not contained in the supernate.

According to a first aspect of the present invention, there are provided a slurry ultrasonic measuring device and a supernate ultrasonic measuring device, the slurry ultrasonic measuring device being distinct from the supernate ultrasonic measuring device, the slurry ultrasonic measuring device including at least one sending transducer and at least one receiving transducer (which may or may not be the same transducer), the supernate ultrasonic measuring device also including at least one sending transducer and at least one receiving transducer (which may or may not be the same transducer). According to this aspect of the present invention, the slurry ultrasonic measuring device can be provided along a pipeline which carries the slurry, can be provided in and/or on a tank in which the slurry is contained, or can be associated with any other kind of vessel in which the slurry is present. For example, the slurry ultrasonic measuring device can be provided in a main pipeline through which the slurry passes, or a tank in which the slurry is contained, or the slurry ultrasonic measuring device can be provided along a loop drawn off of a main pipeline or tank, e.g., a secondary pipeline having an inlet and an outlet, both of which communicate with the main pipeline or tank, with the slurry ultrasonic measuring device being provided between the inlet and outlet, such that a portion of the slurry passing through the main pipeline or tank exits the main pipeline or tank through the inlet to the secondary pipeline, travels through a first portion of the secondary pipeline to the slurry ultrasonic measuring device, passes through the slurry ultrasonic measuring device, passes through a second portion of the secondary pipeline to the outlet, and then passes through the outlet back into the main pipeline or the tank. Similarly, the supernate ultrasonic measuring device can be provided in and/or on any kind of vessel, a pipeline being preferred, and slurry can be drawn off of a main pipeline or tank in a way which is similar to the way slurry can be drawn off for the slurry ultrasonic measuring device as described above, after which the slurry is filtered to provide supernate, at least a portion of which is passed through the supernate ultrasonic measuring device (in a preferred aspect of the invention, a portion of the supernate is collected and used to periodically backwash the filter) and then passed back into the main pipeline or tank. In embodiments where a loop is drawn off of a main pipeline or tank, optionally, a slurry ultrasonic measuring device, a filter and a supernate ultrasonic measuring device can be provided in series, such that the portion of the slurry drawn off through the loop can be passed through the slurry ultrasonic measuring device, the portion of the slurry can then be passed through the filter to produce a supernate, the supernate can then be passed through the supernate ultrasonic measuring device, and the supernate can then be fed back into the main pipeline or tank.

In another preferred aspect of the present invention, a supernate can be analyzed once or any desired number of times, and the results from such analysis can be stored and reused. For example, when a particular slurry is being analyzed, if it is known or assumed that the nature of the supernate will remain approximately the same at different times (e.g., during the entirety of a time span in which a slurry is being analyzed, or during different time spans when slurries having similar supernates are being analyzed), it might be deemed sufficient to obtain a reading for the supernate during a particular time span and consider such a reading to be the reading for that supernate during any other time spans. Information relating to a reading for a supernate during a particular time span can be stored in any suitable way, e.g., in a logbook or in a device-accessible medium, e.g., a computer-readable medium.

In one kind of embodiment according to the present invention, the slurry can be drawn from a main pipeline or tank, stirred to provide better uniformity, and then passed through a slurry ultrasonic measuring device.

In accordance with a preferred aspect of the present invention, the slurry ultrasonic measuring device and the supernate ultrasonic measuring device each have a plurality of pairs of transducers, each pair including a sending transducer and a receiving transducer, each pair of transducers being designed to transmit and receive ultrasonic pulses within different frequency ranges. In this aspect of the invention, a wide range of frequencies can be transmitted, passed through the slurry or supernate and received.

Preferably, the surface (or surfaces) of any vessel on which a transducer (whether it is a sending transducer, a receiving transducer or a sending and receiving transducer) is mounted (and/or through which an ultrasonic signal passes during its travel between being sent and being received) is substantially flat, in order to avoid or reduce any distortion of the signals. For example, by mounting the respective members of a pair of transducers on substantially flat and opposing surfaces, undesired distortion of the amplitude of ultrasonic signals passed from the sending transducer to the receiving transducer, which would otherwise be caused by travel through more curved surfaces and through thicknesses which differ to a greater extent, are reduced or avoided.

Alternatively, however, the surface (or surfaces) of a vessel on which a transducer is mounted can be of any other desired geometry, e.g., curved in order to focus the ultrasonic beams/waves, and discrepancies caused by respective geometries can be compensated by calibration.

In accordance with another aspect of the present invention, there can be provided a system which comprises a tank (which can optionally have one or more inlet and/or one or more outlet, and which can optionally have one or more impeller) with one or more transducer (an optionally one or more reflector) mounted in or on the tank. In such a system, solids sometimes have a tendency to settle toward the bottom of the tank, even when one or more impeller is provided. According to one kind of embodiment, there can be provided a probe device which comprises a sending and receiving transducer and a reflector (“transducer/reflector”), or a sending transducer and a receiving transducer (“transducer/transducer”), mounted in a holder, the holder being mounted in an opening in the bottom of the tank, whereby the holder (along with the transducer/reflector or the transducer/transducer) can be moved up and down within the tank (by moving the holder up and down relative to the opening in the tank), and/or the holder can be rotated within the opening in the tank, whereby different locations (including at different heights) within the tank can be analyzed at different times by the same transducer/reflector or transducer/transducer. In addition, where a transducer/reflector or transducer/transducer is oriented with the gap between the transducer and the reflector, or the gap between the sending transducer and the receiving transducer being vertical or near vertical, solids can sometimes accumulate on the lower component (transducer or reflector), which can sometimes cause distortion. One way to avoid such a phenomenon is to have the transducer/reflector (or transducer/transducer) oriented such that the gap between the transducer and the reflector (or the gap between the sending transducer and the receiving transducer) is horizontal or near horizontal. The up and down moving transducer/reflector or transducer/transducer, rotating transducer/reflector or transducer/transducer and horizontal or near horizontal gap features can all be provided in a single system by providing the holder mounted in an opening in the bottom of the tank (and being movable up and down relative to the opening and being rotatable within the opening) and having a bend of about 90 degrees whereby the gap is horizontal or near horizontal. It should be noted that wherever a transducer/reflector is described herein, it is generally possible to instead employ a transducer/reflector/transducer, i.e., a sending transducer, a reflector and a receiving transducer, oriented relative to one another such that ultrasonic waves sent from the sending transducer are reflected off of the reflector and are later received by the receiving transducer.

In accordance with another aspect of the present invention, there is provided a measuring device comprising:

a bushing having a first bushing end and a second bushing end, a bushing passageway extending between an opening in the first bushing end and an opening in the second bushing end, the bushing comprising a first bushing portion, a second bushing portion and a middle bushing portion, the first bushing portion being adjacent to the first bushing end, at least a portion of the first bushing portion being externally threaded, the second bushing portion being adjacent to the second bushing end, at least a portion of the second bushing portion having external second bushing portion threads, the middle bushing portion being between the first bushing portion and the second bushing portion and extending farther, in all directions perpendicular to a line drawn between the center of the opening in the first bushing end and the center of the opening in the second bushing end than the first bushing portion,

a window portion positioned within a recess in the first bushing end, an outer portion of a first side of the window portion abutting the recess,

a first O-ring in contact with a second side of the window portion, the second side of the window portion being opposite the first side of the window portion,

a second O-ring mounted around the first bushing portion and in contact with the middle bushing portion,

a transducer positioned in the bushing passageway, the transducer having a first transducer end, a second transducer end, a first transducer portion, a second transducer portion and a middle transducer portion, the first transducer portion being adjacent to the first transducer end, the second transducer portion being adjacent to the second transducer end, the middle transducer portion being between the first transducer portion and the second transducer portion, the first transducer end pressing against an inner portion of the first side of the window portion, at least a portion of the second transducer portion having transducer external threads,

a third O-ring mounted around the first transducer portion and being pressed between the middle transducer portion and the second bushing end,

a pressing ring mounted around the second transducer portion, the pressing ring having a first side and a second side, the second side being opposite the first side,

a fourth O-ring mounted around the second transducer portion and being pressed between the first side of the pressing ring and the middle transducer portion,

and a cap having a first cap end and a second cap end, a cap passageway extending from the first cap end to the second cap end, a portion of the cap passageway having internal cap threads, the internal cap threads being threaded on the external second bushing portion threads, an internal surface of the cap pressing against the second side of the pressing ring.

According to the present invention, it is possible to substantially continuously monitor the solid weight percentage in slurries, and to perform such monitoring without interfering substantially with the process operation. The expression “substantially continuously”, as used herein, means obtaining a reading at least once every 10 minutes, preferably obtaining a reading at least once every minute, more preferably obtaining at least 10 readings every minute, more preferably obtaining at least 100 readings every minute, and even more preferably obtaining at least 10 readings every second. The slurry cannot contaminate or corrode the ultrasonic transducers in embodiments where the transducers are disposed outside the pipeline(s), tank(s) and/or other vessel(s) or in the ultrasonic measuring device. In addition, it is unnecessary to measure or know the velocity of the ultrasonic pulses per second, as the value of the attenuation ratio depends only on the path length and the signal voltages.

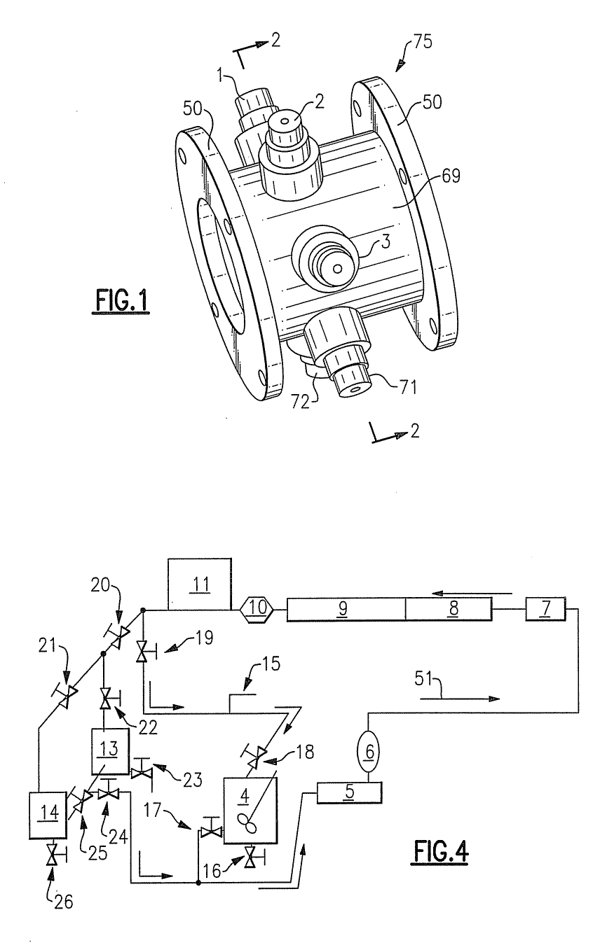

FIGS. 1 and 2A depict embodiments of an ultrasonic measuring device 75 according to the present invention. FIG. 1 is a perspective view of the ultrasonic measuring device 75, and FIG. 2A is a cross-sectional view, taken along a plane which is oriented in the same manner as the plane 2-2 shown in FIG. 1, of a device which is similar to the embodiment shown in FIG. 1 except that the flanges 50 in the device shown in FIG. 2A are larger than the flanges 50 in the device shown in FIG. 1. With reference to FIG. 1 and FIG. 2A, in each case, the ultrasonic measuring device 75 comprises a containment structure 69 in the form of a pipe positioned between a pair of flanges 50. Three pairs of transducers, including sending transducers 1, 2, 3, and corresponding receiving transducers 71, 72, 73, respectively, are installed on the ultrasonic measuring device 75, with each sending transducer opposite its receiving counterpart. The flanges 50 are provided on the inlet and outlet sides of the ultrasonic measuring device 75, for attachment to corresponding flanges on a feed end and an exit end of a pipeline into which the ultrasonic measuring device is to be incorporated.

Referring to FIG. 2A, it can be seen that the respective members of each pair of transducers, 1 and 71, 2 and 72, and 3 and 73, are mounted adjacent to substantially flat and opposing surfaces, such that a section along a plane which is oriented in the same manner as plane 2-2 (in FIG. 1) of the flow path through the passageway 74 has a substantially hexagonal cross-section. The expression “adjacent to”, as used herein, means nearby. For example, where a transducer is positioned such that the wave generating surface of the transducer is spaced from a substantially flat surface in a direction substantially perpendicular to such surface by a distance which is less than the largest dimension of the flat surface, such transducer can be said to be “adjacent to” the substantially flat surface. Preferably, the wave generating surface of a transducer (or each of one or more transducers, or each transducer) is spaced from a substantially flat surface of the interior of the passageway in a direction which is perpendicular to that substantially flat surface by a distance which is less than half, preferably less than one-fourth, of the largest dimension of such substantially flat surface. The expression “substantially flat”, as used herein, means that at least 90% of randomly chosen points in the surface which is characterized as being substantially flat are located on one of or between a pair of planes which are parallel and which are spaced from each other by a distance of not more than 5% of the largest dimension of the surface.

The expression “substantially hexagonal”, as used herein, means that at least 90% of randomly chosen points in the surface which is characterized as being substantially hexagonal are located on one of or between a pair of imaginary hexagonal structures which include regions which are parallel to each other and which are spaced from each other by a distance of not more than 5% of the largest dimension of such region.

The expression “substantially perpendicular”, as used herein, means that at least 90% of randomly chosen points belonging to the plane or structure which is characterized as being substantially perpendicular to a reference plane or line are located on one of or between a pair of planes (1) which are perpendicular to the reference plane, (2) which are parallel to each other and (3) which are spaced from each other by a distance of not more than 5% of the largest dimension of the structure.

By mounting the respective members of each pair of transducers on substantially flat and opposing surfaces, undesired distortion of the amplitude of ultrasonic signals passed from each sending transducer to each receiving transducer, which would otherwise be caused by travel through more curved surfaces and through thicknesses which differ to a greater extent, are reduced or avoided.

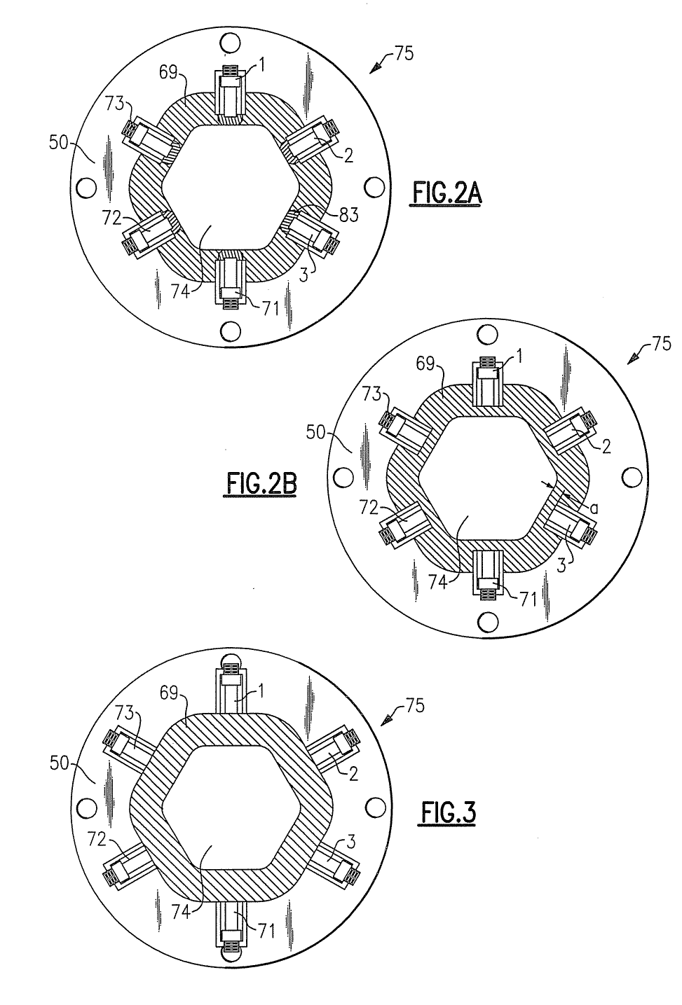

FIG. 2A depicts an embodiment in which the walls of the containment structure 69 have bores into which ends of the transducers 1, 2, 3, 71, 72 and 73 extend and windows 83 which comprise a material having acoustically desirable properties, preferably acoustic properties which are substantially similar to the acoustic properties of the slurry being analyzed. For example, the containment structure 69 can comprise stainless steel, and the windows 83 can comprise an acrylic material. In this embodiment, the ultrasonic pulses travel from the sending transducers (e.g., 1, 2 and 3, through the respective windows 83, through the slurry contained within the passageway 74, through respective opposite windows 83 and into the receiving transducers, 71, 72 and 73, respectively. In the embodiment depicted in FIG. 2A, the containment structure 69 is formed of stainless steel, and the windows 83 are formed of a plastic material, e.g., an acrylic resin or a polyetherimide resin (e.g., ULTEM®). In accordance with the present invention, however, it is not necessary that a containment structure have such bores, as shown in the embodiment depicted in FIG. 3, in which bores are not provided, and the ends of the transducers 1, 2, 3, 71, 72 and 73 abut against the outer surface of the containment structure 69. In the embodiment depicted in FIG. 3, the entire containment structure 69 is formed of a plastic material, e.g., an acrylic polymer or a polyetherimide (e.g., ULTEM®).

FIG. 2B depicts an embodiment in which the walls of the containment structure 69 have bores into which ends of the transducers 1, 2, 3, 71, 72 and 73 extend, such that the ultrasonic pulses travel through small thicknesses of the containment structure 69 (the transducers thus abut outer surfaces of the containment structure 69, albeit within the bores). In the embodiment depicted in FIG. 2B, the entire containment structure 69 is preferably formed of a plastic material, e.g., an acrylic polymer or a polyetherimide (e.g., ULTEM®).

It should be recognized that in each of the devices depicted in FIGS. 2A, 2B and 3, the ultrasonic pulses being sent between each pair of transducers travel through different paths and through different slurry molecules. In addition, slurry may or may not be flowing through the pipes, or slurry may be moving in any manner, e.g., flowing through a pipe, circulating within a containment structure or other vessel, being pushed by a nearby impeller, etc. Nonetheless, ultrasonic pulses traveling between the different pairs of transducers in a measurement device within a measurement cycle (which can be ½ second, much less time or much more time) can be referred to herein as passing through a “single portion” of the slurry. For example, in a given measurement cycle, numerous ultrasonic pulses can be sent through a “first portion” of slurry and received by each of the three pairs of transducers in the embodiment depicted in FIG. 2A. On the other hand, as discussed below, in some embodiments according to the present invention, two or more measuring devices can be placed in or on a single vessel in order to obtain a corresponding number of local readings, i.e., solids concentration estimated values for a corresponding number of locations within the vessel. In addition, the same applies where a transducer/reflector is employed or where a reflector is used with both a sending transducer and a receiving transducer.

In carrying out a maximum slope method or a concentration vs. attenuation ratio method, the received signal is preferably first converted into digital form. In order to do so, a preferred range in which the voltages of the received signals fall (including positive and negative values) is preferably divided into a number of sub-ranges, each sub-range preferably having a similar range of values (i.e., the highest value in the sub-range minus the lowest value in the sub-range is approximately the same for each sub-range), the number of sub-ranges preferably being 2ⁿ, where n is an integer. If some (or all) of the received signals fall outside the preferred range, or if the received signals fall within a significantly smaller range, the amplitude of the signals being sent is preferably adjusted appropriately so that the received signals will be within the preferred range and vary over a significant portion of the preferred range. The received signals from respective transducers can be amplified by different factors, as needed. Any suitable device for amplifying voltage signals can be employed, a variety of such devices being well known to those of skill in the art.

In carrying out a maximum slope method or a concentration vs. attenuation ratio method, after converting the digital signals to real physical values, a spectral transform, preferably a Fourier Transform, more preferably a Digital Fourier Transform such as Fast Fourier Transform (FFT) is then performed over the range of frequency components, to obtain the spectrum of each signal. The spectra from each of the measuring devices are preferably then combined to produce an overall attenuation curve, that is, one attenuation data point for each frequency component studied.

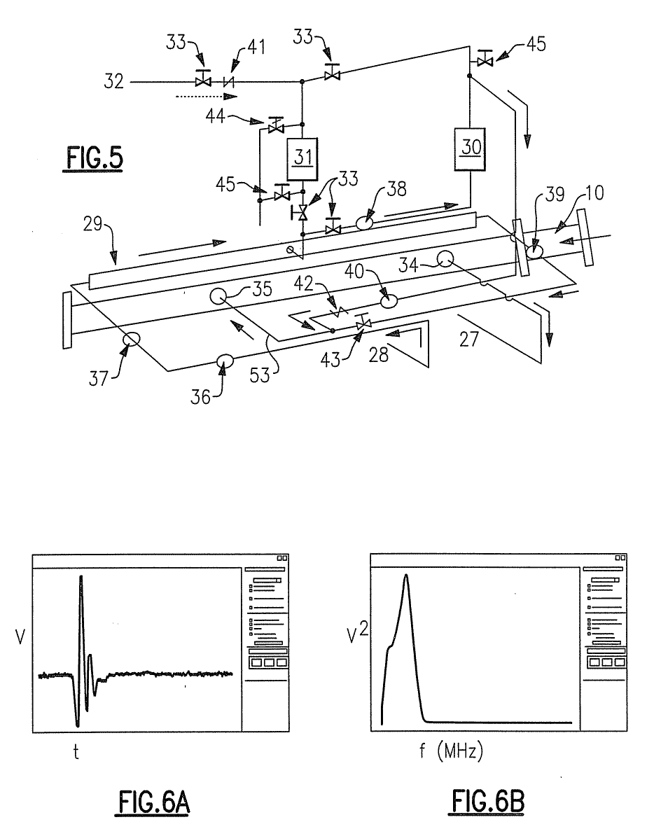

FIGS. 4 and 5 depict an embodiment of a system which was used to test the effectiveness of an acoustic monitor employing a method according to the present invention. Such a system can also be used for calibrating acoustic monitors. The system depicted in FIG. 4 includes a main flow loop 51, in which a slurry measuring device 10 and a filtration system equipped with the supernate measuring device 11 are installed. FIG. 5 depicts in detail the filtration system 11, in which a supernate measuring device 30 is installed.

The slurry of interest is added to the system via a continuously stirred vessel 4 and circulated through the main flow loop by a pump 5. Various process control elements are installed in the main flow loop. These include a flowmeter 6, an inline helical mixer 7, and a flow window 9. The in-line gas bubbler 8 is used to generate gas bubbles in the process stream at various concentrations, thus allowing the study of the effects of bubbles on the accuracy of the system. A sample port 15 is installed to extract samples from the flow loop. These samples can be studied to obtain the actual concentration in the flow loop at a given time, thus providing a standard with which to compare the measurements of the acoustic monitor. Two extra tanks 13, 14 are included for the purpose of cleaning the system. Several valves 16-26 are installed for directing flow through the loop and draining the three tanks 4, 13, 14.

Approximately 5% of the main flow is drawn out of the main loop 34 and into the filtering system with the supernate measuring device 11 at the inlet 27 of a second pump. The exit 28 of this pump leads into a cross-flow concentric tube filter 29 (e.g., a microporous cross-flow filter). By passing through the filter 29, solids and at least some bubbles are removed from the slurry, to produce supernate. The bulk of the slurry is returned to the main loop 35 via return line 53. The rest of the supernate is used in one of two ways. A primary part is passed through the supernate measuring device 30 before returning to the main loop 35. A secondary part is used to clean the filter 29—supernate can be stored in a 1 liter high-pressure backpulse vessel 31 for use in a backpulsing process used to clean the filter 29.

The backpulsing process consists of manipulating four solenoid valves 33 according to an operating program to allow a burst of high-pressure air 32 to enter the backpulse vessel 31, thus forcing the stored filtrate solution back through the filter 29. This process forces solid particles out of the pores of the filter 29, back into the flow. Preferably, the pressure drop across the filter is monitored by various pressure gauges in the side stream. Optionally, the backpulsing system can be completely automated; alternatively, a user can select a specific time interval for backpulsing or the user can “manually” backpulse the filter. In the “manual” mode, the system operator preferably monitors the pressure gauges and decides to backpulse the system, but the actual backpulsing process is still controlled electronically via solenoid valves.

The remaining equipment in the system includes flowmeters for the side stream 36 and supernate stream 40; pressure gauges at the filter inlet 37 and outlet 39 and for the supernate stream 38; check valves for the supernate stream exit 42 and the high-pressure air source 41; a pressure release valve for the backpulse system 44; a regulating valve for the filter 43; and valves for cleaning the side stream or for emergency use 45.

As noted above, α is determined for at least one frequency (in a concentration vs. attenuation ratio method) or for each of a number of frequencies (in a maximum slope method), by producing an ultrasonic signal at the frequency being employed, causing the ultrasonic signal to pass through at least a portion of the slurry being examined, and then receiving the ultrasonic signal, and the amplitude of the received signal is obtained by detecting the voltage of the received signal. In a maximum slope method, α is preferably determined for a number of frequencies in rapid succession. In such a way, it is possible to collect the readings needed to determine the solids percentage in the slurry being analyzed in a relatively short period, e.g., on the order of 1-10 milliseconds or less, making it possible to monitor solids percentage on a substantially real-time basis.

As noted above, in a preferred aspect of the present invention, for performing a maximum slope method, the slurry measuring device and the supernate measuring device each have a plurality of pairs of transducers, each pair including a sending transducer and a receiving transducer, each pair of transducers being designed to send and receive ultrasonic pulses within different frequency ranges. In a representative example, for instance, in each measuring device, there can be three pairs of transducers, the first pair for sending and receiving pulses in the range of from about 0.6 MHz to about 4 MHz (such as a pair of 2.25 MHz nominal transducers), the second pair for sending and receiving pulses in the range of from about 2.5 MHz to about 7.5 MHz (such as a pair of 5 MHz nominal transducers), and the third pair for sending and receiving pulses in the range of from about 6 MHz to about 12 MHz (such as a pair of 10 MHz nominal transducers).

For example, similar to the measuring devices depicted in FIGS. 1 and 2 as discussed above, each of the two measuring devices can include three pairs of ultrasonic transducers used simultaneously to provide signals with a broad range of frequencies for data collection and analysis (typically 0.6-12 MHz). The transducers used most frequently have nominal frequencies of 2.25 MHz, 5 MHz, and 10 MHz. Alternatively, for example, a pair of transducers can be used at a nominal frequency of 7.5 MHz. A pulse generator preferably produces short rectangular pulses (e.g., duration ˜50 ns, amplitude −125V) with a broad frequency spectrum.

An example of a typical shape of a received signal is depicted in FIG. 6A. An example of a typical shape of a received signal for a pair of 10 MHz nominal transducers is depicted in FIG. 6A, which is a plot of voltage (Y axis) vs. time (X axis). An example of a typical shape of a spectrum of the received signal for a pair of 10 MHz nominal transducers is shown in FIG. 6B, which is a plot of voltage squared (Y axis) vs. frequency (MHz). Preferably after taking a certain number of samples from each channel in a cyclic manner, these data are averaged to produce a spectrum for each channel. The system preferably automatically adjusts the acquired signals during data acquisition to ensure accuracy. Specifically, if the signal is too high or low, amplification is preferably automatically decreased or increased, respectively. Such amplification can differ for different transducers (e.g., one level for a slurry transducer having a main frequency of 2.25 MHz, a different level for a supernate transducer having a main frequency of 2.25 MHz, a different level for a slurry transducer having a main frequency of 5.0 MHz, a different level for a supernate transducer having a main frequency of 5.0 MHz, a different level for a slurry transducer having a main frequency of 10.0 MHz, and a different level for a supernate transducer having a main frequency of 10.0 MHz.

In theory, comparing ultrasound amplitude (or energy) received in the slurry with ultrasound amplitude (or energy) received in the supernate is relatively straightforward. That is, one would send sine (monochromatic) waves through the slurry and through the supernate, and compare the amplitudes of the received waves (also monochromatic). However, in practice, it is generally very difficult to send such waves, and the devices are able instead to generate ultrasonic signals which are not of perfect sinusoidal shape, and which therefore transmits energy in a range of frequencies. In order to obtain the energy transmitted by the non-sinusoidal signal in a specific frequency, a spectral analysis procedure can be employed.

Fast Fourier transform (FFT) is a technique for effectively implementing spectral analysis of received ultrasonic signals. While other methods can be used, such other methods are usually less effective for obtaining the spectrum (although sometimes such other methods are more effective than the FFT technique). FFT is typically particularly effective for digitally represented signals in which the number of readings can be expressed as N=2ⁿ.

Preferably, the detected amplitude values are adjusted prior to calculating α values. This adjustment is done to account for differences in acoustic responses in the respective acoustical channels (i.e., from sending transducer to receiving transducer) at different frequencies, due, e.g., to differences in physical properties of connecting wires, transducers, coupling gels, wall thicknesses and wall properties. In order to generate an adjustment factor, a slurry measuring device including a sending transducer and a receiving transducer (which can be a single transducer which functions as both a sending transducer and a receiving transducer, as discussed above) which is going to be used over a particular frequency or frequency range for the slurry, and a supernate measuring device sending transducer and a receiving transducer (which can likewise be a single transducer which functions as both a sending transducer and a receiving transducer) which is going to be used over a similar frequency or frequency range for the supernate, are filled with similar solutions, and similar signals are sent to each of the sending transducers. The detected respective values of the square of the received voltage are compared. The ratio of the square of the received voltage for the transducer pair in the supernate measuring device, divided by the square of the received voltage for the transducer pair in the slurry measuring device, is the adjustment factor for those transducer pairs at that particular frequency. When calculating the α value for that particular frequency in use (i.e., when the supernate measuring device is filled with supernate and the slurry measuring device is filled with slurry), the detected value for the square of the received voltage in the transducer in the slurry measuring device is multiplied by the adjustment factor for those transducer pairs at that particular frequency. The above-described procedure for determining an adjustment factor is repeated for each of the transducers (i.e., each sending transducer and receiving transducer pair or sending and receiving transducer in the slurry measuring device and in the supernate measuring device) at each frequency for which α is going to be calculated, and each calculation of α at a particular frequency is carried out using the adjustment factor for that particular frequency.

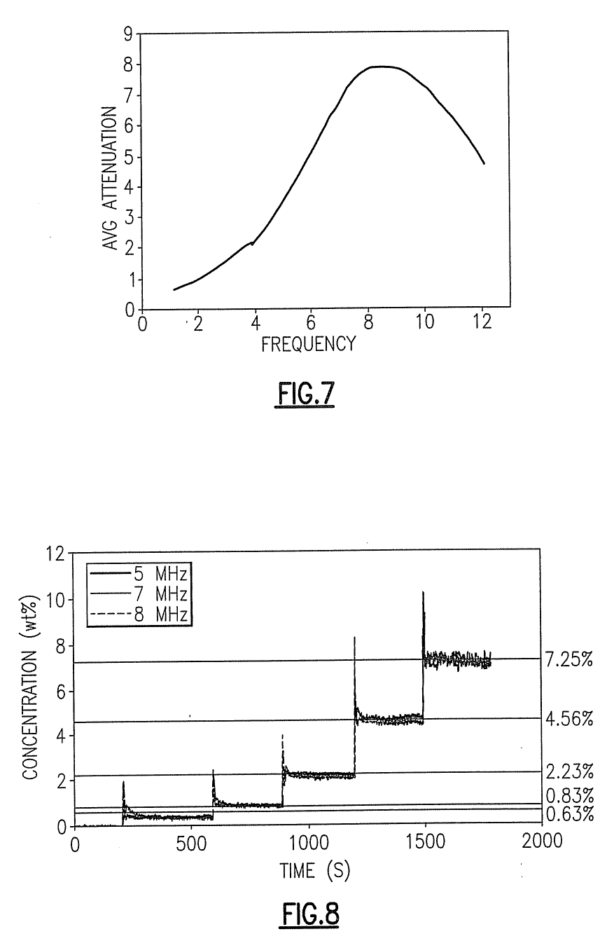

FIG. 7 shows a typical attenuation ratio vs. frequency curve for 7.5 wt % ceramic microspheres in water.

The response time of the acoustic monitor is quite fast (0.5 s) as can be seen from FIG. 8, which shows the measured concentration (horizontal lines at 0.63%, 0.83%, 2.23%, 4.56% and 7.25%) in weight percentage as a function of time in a slurry consisting of ceramic microspheres suspended in water as well as concentration detected using a using concentration vs. attenuation ratio method (plots). The concentration is changed stepwise by adding known amounts of solids to the mixing tank. Actual concentration measurements from an in-line sampling port 15 (see FIG. 4) are labeled on the right axis and expressed by horizontal lines in FIG. 8. These results show excellent accuracy in measurements of the actual solids concentration up to 7.25 wt % at 5, 7, and 8 MHz. These measurements were recorded in substantially real time and demonstrate rapid response to instantaneous changes in solids concentration. The spikes shown (duration 8 seconds) occur when the solids are added to the mixing vessel 4 and represent the initial pulse through the pipeline before the solids are homogeneously mixed.

The concentration measurements from the acoustic monitor (measured) are plotted against measurements from the in-line sample port 15 (actual) in FIG. 9. It is evident from this figure that most data fall on the parity line and, thus, compare well with expectations. The acoustic data and sample port data can be compared using a percent average absolute relative deviation (AARD), which is the absolute difference between the actual and measured concentrations divided by the actual concentration, or

$$AARD = {\sum }_{i = 1}^{n} ( \frac{\vert {C}_{measured , i} - {C}_{actual , i} \vert}{{}_{-}^{}{C}{}_{measured , i}^{}} ) \times 100 \%$$

The AARD for the entire experiment (0-8 wt %) is 11%. If the data at 0.5 weight percent solids are not included (comparative error is expected to be exaggerated when using small numbers), the AARD is 3% for 1-8 wt %.

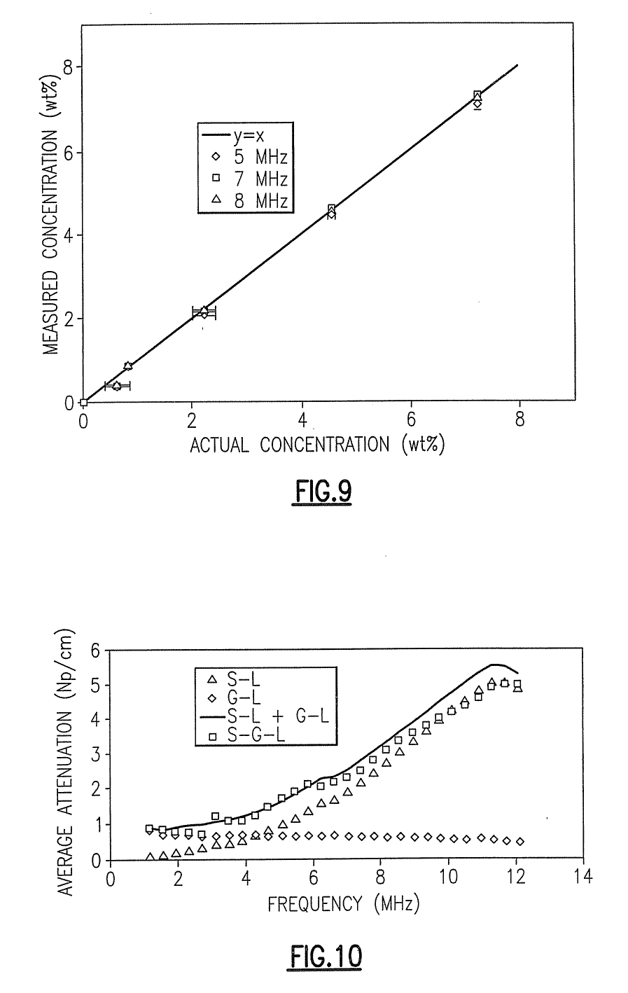

FIG. 10 shows a comparison of data from various studies. In all four data series, water is used as the liquid, 0.1 vol % air as the gas, and 2.5 wt % ceramic microspheres as the solids. The first two series show data from separate studies using solid-liquid and gas-liquid systems, respectively. The third series is a summation of the average attenuations from the solid-liquid and gas-liquid studies at each frequency. The final series shows experimental data from a solid-gas-liquid system. The solid-gas-liquid data are similar to the summation series at lower frequencies. As the frequency increases, however, the S-G-L data collapse on the S-L curve. Thus, the attenuation of the gas bubbles cannot simply be subtracted from the solid-gas-liquid data to receive the underlying attenuation due to solids.

FIG. 11 shows the response of the acoustic monitor to real-time experiments in the main loop of FIG. 4. A solid concentration (about 1.0 wt %) is established and allowed to reach steady state, after which air bubbles are introduced as five stepwise concentration changes at five-minute intervals in the range of 0.005 to 0.1 vol %. The upper curve represents the predicted solids concentration if the presence of bubbles is not accounted for in the analysis using a concentration vs. attenuation ratio method. The lower curve shows the results obtained using the maximum slope method. The measured attenuation at 7 MHz increases as more bubbles are introduced, but the solid concentration measured via the maximum slope method is practically unaffected by the increase in bubble volume fraction. In fact, if the operator did not know that bubbles were present, the 7 MHz curve would be interpreted as a solid concentration at all times, leading to a 42% AARD, compared with the typical 3% AARD for 1 wt % G-800.

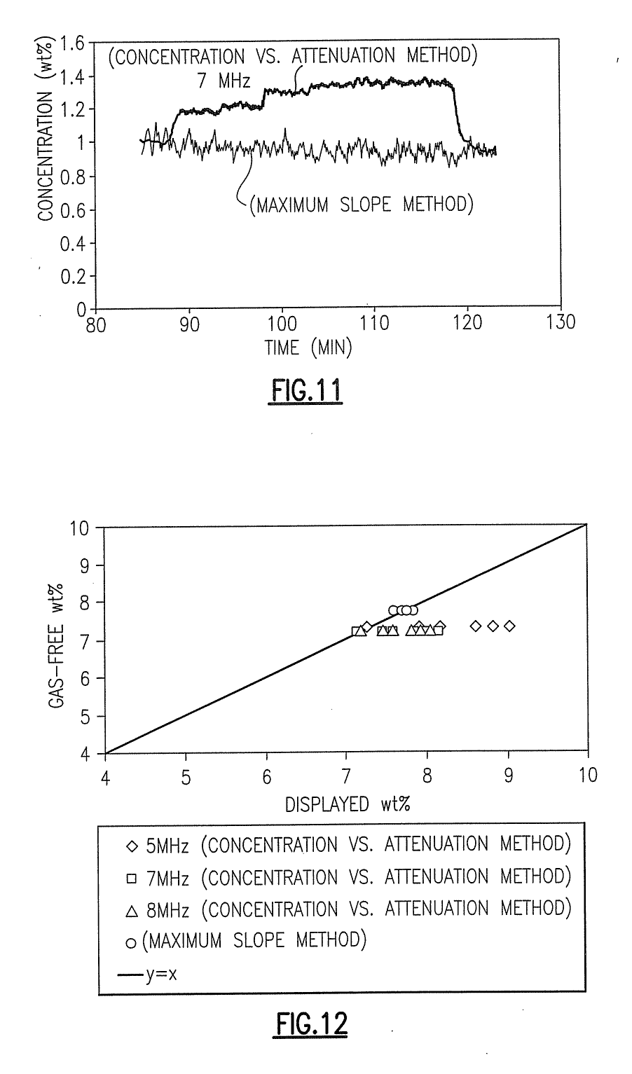

FIG. 12 shows data from experiments with a slurry composed of two parts kaolin to one part bentonite in water. The data are analyzed both using a concentration vs. attenuation ratio method and using the maximum slope method. The solid concentration is held constant at approximately 7 wt % while the gas concentration is increased stepwise from 0 to 0.1 vol %. The average value of concentration calculated by the maximum slope method and by the attenuation method at three frequencies (5, 7, and 8 MHz) are plotted on the x-axis with the actual concentration (Gas-Free wt %) on the y-axis.

Although the effect of gas bubbles on concentration vs. attenuation ratio methods is less evident at higher than lower concentrations, FIG. 12 shows a large spread in the data over the range of gas concentrations (25%, 14%, and 12% AARD for 5 MHz, 7 MHz, and 8 MHz concentration vs. attenuation ratio methods, respectively). As expected, this spread is wider for lower frequencies. Also, as the gas concentration is increased, the perceived solid concentration increases as well. However, the variations in the data from the maximum slope method are completely random and the spread of the data is significantly more narrow (4% AARD) than even the 8 MHz data.

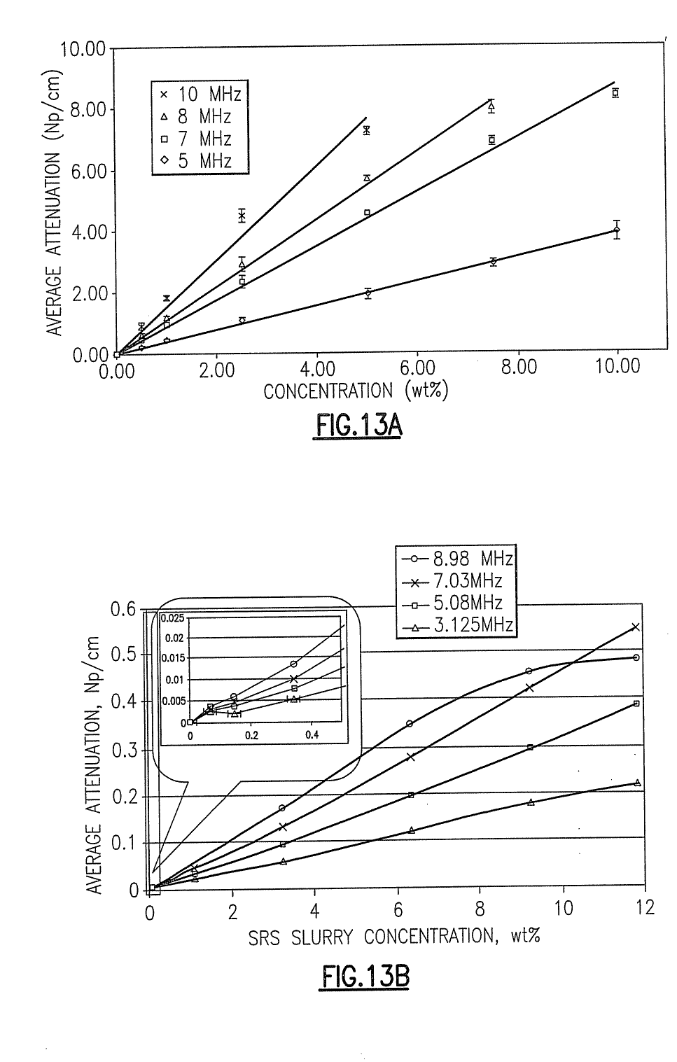

FIG. 13A depicts representative examples of plots of concentration vs. attenuation ratio for a ceramic bead slurry at various frequencies (namely, 5 MHz, 7 MHz, 8 MHz and 10 MHz), in which the plots are substantially linear.

FIG. 13B depicts additional representative examples of plots of concentration vs. attenuation ratio for a simulant slurry of radioactive waste from Savannah River Site (SRS) at various frequencies (namely, 3.125 MHz, 5.08 MHz, 7.03 MHz and 8.98 MHz), in which the plots are substantially linear.

As indicated above, the one or more transducer can be arranged in any desired way relative to a containment structure, such that one or more ultrasonic pulse can be directed through a portion of the material (e.g., slurry or supernate) contained within the containment structure.

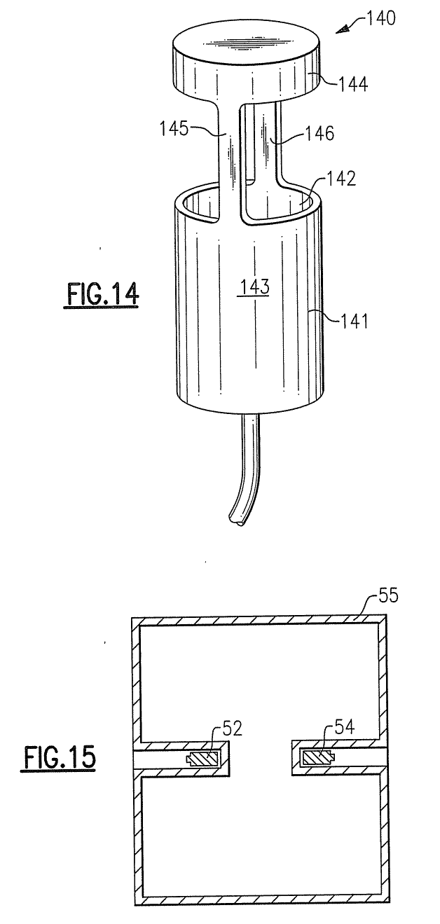

For example, FIG. 14 depicts an embodiment of a device 140 which includes a bracket 141 and a sending and receiving transducer 142. The bracket 141 comprises a body portion 143, in which the transducer 142 is positioned, a cap portion 144 and a pair of strand structures 145 and 146 which connect the cap portion 144 to the body portion 143. The lower side (in the perspective shown in FIG. 14) of the cap portion 144 is a reflector. The device depicted in FIG. 14 can be used, for example, by dipping the device 140 (in any desired orientation) into a slurry, sending ultrasonic pulses from the transducer 142 and receiving the ultrasonic pulses with the transducer 142 after the pulses have traveled through the slurry, been reflected by the cap portion 144 and traveled back through the slurry. Preferably, the opposite side of the cap portion 144, i.e., the side which faces away from the transducer 142, is roughened in order to reduce or avoid ultrasonic waves being reflected by the opposite side instead of the reflector.

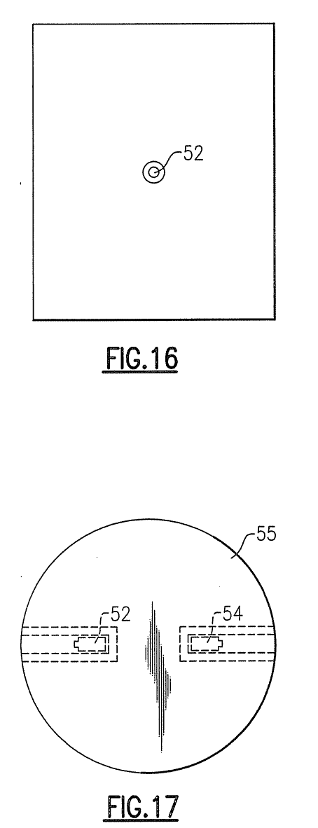

In another example, FIG. 15 depicts an arrangement in which a sending transducer 52 and a receiving transducer 54 are mounted within indented regions (formed, e.g., by cutting holes in the wall of the containment structure 55, inserting pipe sections into the respective holes, and welding the pipe sections in place) of a containment structure 55 (e.g., a tank). FIG. 16 is a side view of the containment structure of FIG. 15, showing one of the indented regions in which the sending transducer 52 is positioned. FIG. 17 is a top view of the containment structure of FIG. 15.

In another example, FIG. 18 depicts an arrangement in which a sending transducer 56 and a receiving transducer 57 are mounted within indented regions of a containment structure 58 (e.g., a tank).

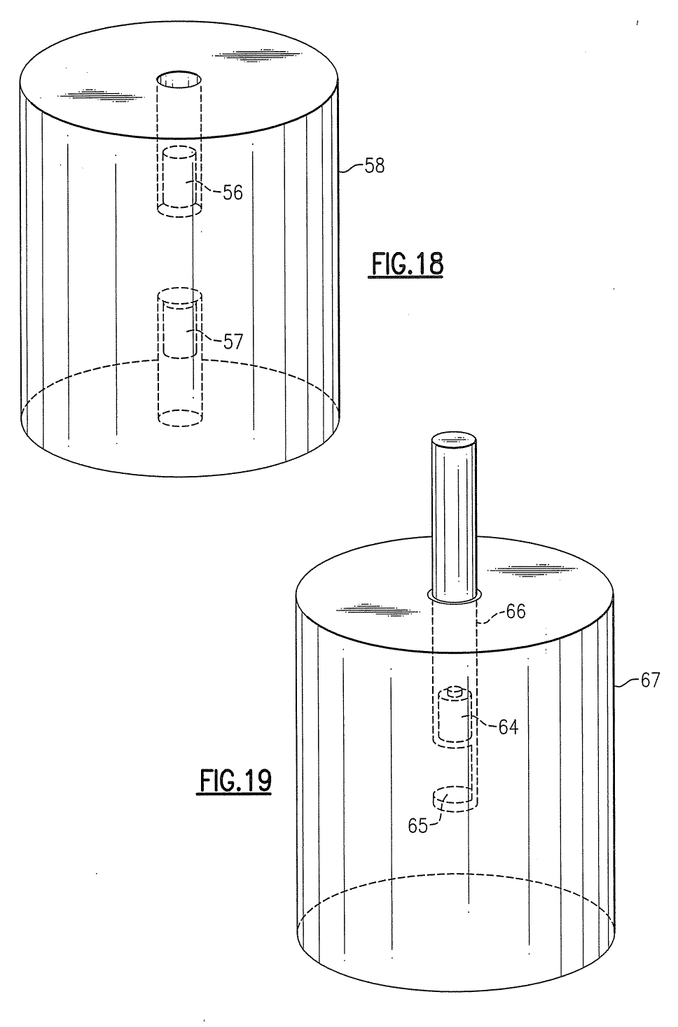

In another example, FIG. 19 depicts an arrangement in which a sending and receiving transducer 64 and a reflector 65 are mounted on a bracket 66 which extends into a containment structure 67 (e.g., a tank).

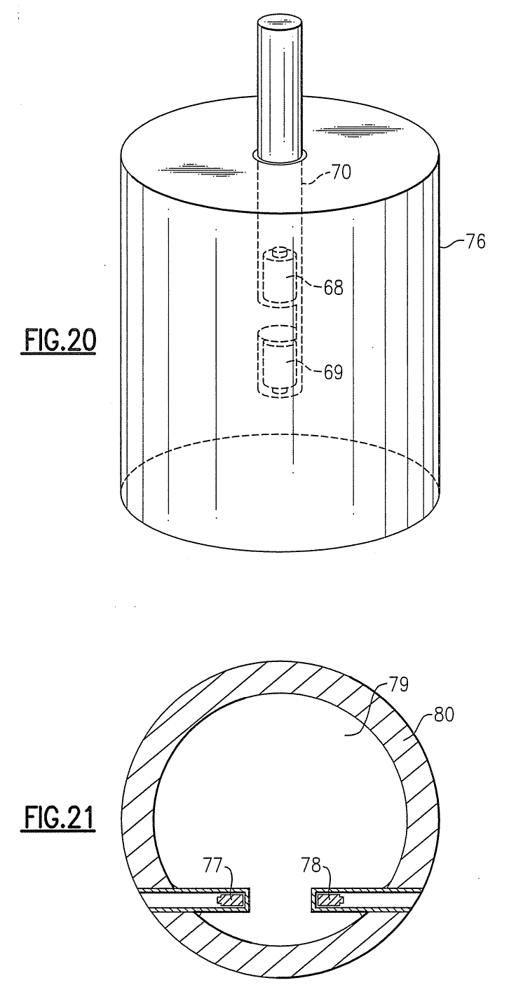

In another example, FIG. 20 depicts an arrangement in which a sending transducer 68 and a receiving transducer 69 are mounted on a bracket 70 which extends into a containment structure 76 (e.g., a tank).

In another example, FIG. 21 depicts an arrangement in which a sending transducer 77 and a receiving transducer 78 are mounted within indented regions (e.g., sealed pipes welded within holes formed in a containment structure 80) in the containment structure 80, (e.g., a pipe). Alternatively, a sending and receiving transducer can be used in place of the sending transducer, and a reflector can be used in place of the receiving transducer.

In another example, FIG. 22 depicts an arrangement which includes a tank 150, an impeller shaft 151, a plurality of impeller baffles 152, 153, 154, 155 and 158, a holder 156 and a measuring device 157 including a sending and receiving transducer 159 and a reflector 159a (alternatively, as discussed above, the measuring device could instead include (a) a sending transducer and a receiving transducer or (b) a sending transducer, a reflector and a receiving transducer). In this embodiment, the holder 156 can be moved up or down such that the measuring device 157 can be used at different levels within the tank 150. In addition, the holder 156 can be rotated about its vertical axis. In addition, the holder 156 has a 90 degree bend, such that the gap between the transducer and the reflector is horizontal.

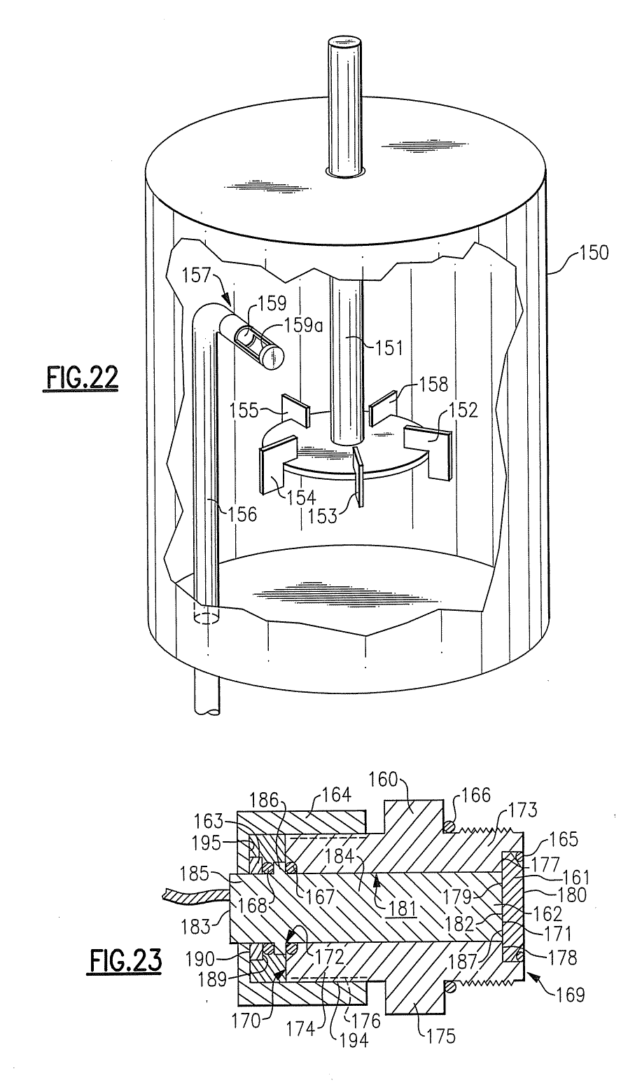

FIG. 23 depicts an embodiment of a measuring device which comprises a bushing 160, a window portion 161, a transducer 162, a pressing ring 163, a cap 164, a first O-ring 165, a second O-ring 166, a third O-ring 167 and a fourth O-ring 168.

The bushing 160 has a first bushing end 169 and a second bushing end 170. A bushing passageway 181 extends between an opening 171 in the first bushing end 169 and an opening 172 in the second bushing end 170. The bushing 160 comprises a first bushing portion 173, a second bushing portion 174 and a middle bushing portion 175. The first bushing portion 173 is adjacent to the first bushing end 169. A portion of the first bushing portion 173 is externally threaded. The second bushing portion 174 is adjacent to the second bushing end 170. A portion of the second bushing portion 174 has external second bushing portion threads 176. The middle bushing portion 175 is between the first bushing portion 173 and the second bushing portion 174. The middle bushing portion 175 extends farther, in all directions perpendicular to a line drawn between the center of the opening 171 in the first bushing end 169 and the center of the opening 172 in the second bushing end 170 than the first bushing portion 173.

The window portion 161 is positioned within a recess 177 in the first bushing end 169. An outer portion 178 of a first side 179 of the window portion 161 abuts the recess 177.

The first O-ring 165 is in contact with a second side 180 of the window portion 161. The second side 180 of the window portion 161 is opposite the first side 179 of the window portion 161.

The second O-ring 166 is mounted around the first bushing portion 173 and is in contact with the middle bushing portion 175.

The transducer 162 is positioned in the bushing passageway 181. The transducer 162 has a first transducer end 182, a second transducer end 183, a first transducer portion 184, a second transducer portion 185 and a middle transducer portion 186. The first transducer portion 184 is adjacent to the first transducer end 182. The second transducer portion 185 is adjacent to the second transducer end 183. The middle transducer portion 186 is between the first transducer portion 184 and the second transducer portion 185. The first transducer end 182 presses against an inner portion 187 of the first side 179 of the window portion.

The third O-ring 167 is mounted around the first transducer portion 184 and is pressed between the middle transducer portion 186 and the second bushing portion 174.

The pressing ring 163 is mounted around the second transducer portion 185, the pressing ring having a first side 189 and a second side 190, the second side 190 being opposite the first side 189.

The fourth O-ring 168 is mounted around the second transducer portion 184 and is pressed between the first side 189 of the pressing ring and the middle transducer portion 186.

A portion of the cap has internal cap threads 194 which are threaded on the external second bushing portion threads 176. An internal surface 195 of the cap 164 presses against the second side 190 of the pressing ring 163. As the internal cap threads 194 are threaded onto the external second bushing portion threads 176, the internal surface 195 of the cap 164 pushes the pressing ring 163, which in turn presses the fourth O-ring 168 against the middle transducer portion 186.

The measuring device depicted in FIG. 23 can be employed by screwing the external threads on the first bushing portion 173 into female threads on a containment structure such as the containment structure 69 depicted in FIG. 1.

As the internal cap threads 194 are threaded onto the external second bushing portion threads 176, the first transducer end 182 presses against the window portion 161, which in turn pushes the first O-ring 165 against the containment structure, thereby providing a primary seal between the containment structure and the measuring device.

In the event that the window portion 161 breaks or otherwise fails, this embodiment provides back-up seals. That is, as the internal cap threads 194 are threaded onto the external second bushing portion threads 176, the middle transducer portion 186 pushes the third O-ring 167 against the second bushing portion 174, thereby providing a back-up seal between the transducer 162 and the inner surface of the bushing 160. In addition, as the bushing 160 is threaded into the containment structure (i.e., as the external threads on the first bushing portion 173 are threaded into the female threads on the containment structure), the middle bushing portion 175 presses the second O-ring 166 against the containment structure, thereby providing a back-up seal between the containment structure and the outer surface of the bushing 160.

In addition, in the embodiment depicted in FIG. 23, the bushing 160, the outer portion of the middle transducer portion 186 and the outer portion of the second transducer portion can all be made of a very hard and durable material, e.g., stainless steel, thereby providing excellent mechanical strength.

The above examples of arrangements are representative only, and a wide variety of structures can be used to position a sending transducer and a receiving transducer (or a sending and receiving transducer and a reflector) opposite to one another relative to a portion of a material within a containment structure, and all such structures are within the scope of the present invention. In addition, while it is preferred that the one or more transducer be mounted at a location such that it does not (or they do not) come into contact with the material contained within the containment structure, if desired, the one or more transducer can be mounted within the containment structure such that it comes into contact with material contained within the containment structure.

While this invention has been described in detail with reference to the preferred embodiments, it should be understood that many modifications and variations would be apparent to those of skill in the art without departing from the scope and spirit of this invention as defined in the appended claims.

Any two or more structural parts of the devices described herein can be integrated. Any structural part of the devices described herein can be provided in two or more parts which are held together, if necessary. Similarly, any two or more functions can be conducted simultaneously, and/or any function can be conducted in a series of steps.

1. A measuring device comprising:
a measuring device body having a passageway extending therethrough; and
at least a first sending transducer which sends ultrasonic pulses, said first sending transducer being mounted on said measuring device body.

2. A measuring device as recited in claim 1, further comprising at least a first receiving transducer which receives said ultrasonic pulses, said first receiving transducer being mounted on said measuring device body opposite said first sending transducer relative to at least a portion of said passageway.

3. A measuring device as recited in claim 2, wherein at least a sending portion of said first sending transducer is positioned outside a periphery of said passageway.

4. A measuring device as recited in claim 3, wherein at least a receiving portion of said first receiving transducer is positioned within a periphery of said passageway.

5. A measuring device as recited in claim 3, wherein at least a receiving portion of said first receiving transducer is positioned outside a periphery of said passageway.

6. A measuring device as recited in claim 2, wherein at least a sending portion of said first sending transducer is positioned within a periphery of said passageway.

7. A measuring device as recited in claim 6, wherein at least a receiving portion of said first receiving transducer is positioned within a periphery of said passageway.

8. A measuring device as recited in claim 6, wherein at least a receiving portion of said first receiving transducer is positioned outside a periphery of said passageway.

9. A measuring device as recited in claim 2, further comprising:
a second sending transducer which sends ultrasonic pulses, said second sending transducer being mounted on said measuring device body;
a second receiving transducer which receives ultrasonic pulses sent by said second sending transducer, said second receiving transducer being mounted on said measuring device body opposite said second sending transducer relative to at least a portion of said passageway;
a third sending transducer which sends ultrasonic pulses, said third sending transducer being mounted on said measuring device body; and
a third receiving transducer which receives ultrasonic pulses sent by said third sending transducer, said third receiving transducer being mounted on said measuring device body opposite said third sending transducer relative to at least a portion of said passageway.

10. A measuring device as recited in claim 9, said first sending transducer sending ultrasonic pulses having frequencies within a first range, said second sending transducer sending ultrasonic pulses having frequencies within a second range, said third sending transducer sending ultrasonic pulses having frequencies within a third range, said second range differing from said first range, said third range differing from said second range and from said first range.

11. A measuring device as recited in claim 9, wherein said passageway is defined by a plurality of wall segments defined within said measuring device body, said plurality of wall segments comprising at least a first wall segment, a second wall segment, a third wall segment, a fourth wall segment, a fifth wall segment and a sixth wall segment, said first, second, third, fourth, fifth and sixth wall segments each being substantially flat, said first sending transducer being mounted adjacent to said first wall segment, said second sending transducer being mounted adjacent to said second wall segment, said third sending transducer being mounted adjacent to said third wall segment, said first receiving transducer being mounted adjacent to said fourth wall segment, said second receiving transducer being mounted adjacent to said fifth wall segment, said third receiving transducer being mounted adjacent to said sixth wall segment.

12. A measuring device as recited in claim 11, wherein a cross-section of said passageway is substantially hexagonal, said first wall segment, said second wall segment, said third wall segment, said fourth wall segment, said fifth wall segment and said sixth wall segment together defining walls of said passageway.

13. A measuring device as recited in claim 2, wherein said first sending transducer and said first receiving transducer are mounted on outside surfaces of said measuring device body, said passageway being defined by inside surfaces of said measuring device body.

14. A measuring device as recited in claim 1, wherein said first sending transducer also receives said ultrasonic pulses.

15. A measuring device as recited in claim 14, wherein:
said measuring device further comprises at least one reflecting plate positioned and oriented such that at least a portion of ultrasonic pulses sent from said first sending transducer are reflected by said reflecting plate and are then received by said first sending transducer.

16. A measuring device as recited in claim 1, further comprising at least a first reflector which reflects said ultrasonic pulses, and at least a first receiving transducer which receives said ultrasonic pulses, said first sending transducer and said first receiving transducer being mounted on said measuring device body relative to said reflector such that at least a portion of ultrasonic waves sent from said sending transducer is reflected by said reflector and then received by said receiving transducer.

17. A measuring device as recited in claim 1, wherein said measuring device body comprises at least one bore and at least one window portion, said window portion extending from an inside wall of said bore to said passageway, said first sending transducer being positioned within said bore.

18. A measuring device as recited in claim 1, wherein:
said measuring device further comprises at least one receiving transducer,
said measuring device body comprises at least one bore and at least one window portion,
said window portion extends from an inside wall of said bore to said passageway, and
said first receiving transducer is positioned within said bore.

19. A measuring device as recited in claim 1, wherein:
said measuring device further comprises at least one receiving transducer,
said measuring device body comprises at least a first bore, a second bore, a first window portion and a second window portion,
said first window portion extends from an inside wall of said first bore to said passageway,
said first sending transducer is positioned within said first bore,
said second window portion extends from an inside wall of said second bore to said passageway, and
said first receiving transducer is positioned within said second bore.

20. A measuring device as recited in claim 1, further comprising a second sending transducer which sends ultrasonic pulses, said second sending transducer being mounted on said measuring device body, said first sending transducer sending ultrasonic pulses having frequencies within a first range, said second sending transducer sending ultrasonic pulses having frequencies within a second range, said second range differing from said first range.

21. A measuring device as recited in claim 20, wherein said second frequency range and first frequency range partially overlap.

22. A measuring device as recited in claim 1, wherein said passageway is defined by a plurality of wall segments defined within said measuring device body, said plurality of wall segments comprising at least a first wall segment, said first wall segment being substantially flat, said first sending transducer being mounted adjacent to said first wall segment.

23. A measuring device as recited in claim 1, further comprising at least one device accessible medium containing data.

24. A measuring device as recited in claim 23, wherein said data comprises at least one reading obtained by removing solid material from a portion of a slurry to provide a filtered liquid, passing at least one ultrasonic pulse through said portion of said slurry, and measuring amplitude of said ultrasonic pulse after passing through said filtered liquid.

25. A measuring device as recited in claim 23, wherein said device accessible medium containing data is a computer-readable database.

26. (canceled)

27. A system for estimating a concentration of solids in a slurry, comprising:
a first containment structure defining a first space for receiving at least a portion of a slurry;
a second containment structure defining a second space for receiving at least a liquid material included in said slurry,
at least a first receiving transducer mounted on said first containment structure; and
at least a second receiving transducer mounted on said second containment structure.

28. A system as recited in claim 27, wherein said second containment structure communicates with said first containment structure through at least one filter for removing solid materials from said slurry.

29-70. (canceled)
